(19) United States
(12) Patent Application Publication
(10) Pub. No.: US 2014/0379418 A1
(43) Pub. Date: Dec. 25, 2014

(54) METHODS, SYSTEMS AND NON-TRANSITORY COMPUTER-READABLE MEDIA FOR CALCULATING A RISK ASSOCIATED WITH A PROJECT

(71) Applicant: Infosys Limited, Bangalore (IN)

(72) Inventors: Harish Kulkarni, Bangalore (IN); Vasudeva Naidu, Bangalore (IN); Srinivas Yeluripaty, Bangalore (IN); Sugam Srivastava, Bangalore (IN); Sunil Gupta, Bangalore (IN); Srikanth Reddy, Bangalore (IN)

(73) Assignee: Infosys Limited, Bangalore (IN)

(21) Appl. No.: 14/220,685

(22) Filed: Mar. 20, 2014

(30) Foreign Application Priority Data
Jun. 24, 2013 (IN) 2726/CHE/2013

(51) Int. Cl. G06Q 10/06

(52) U.S. Cl. CPC G06Q 10/0635
USPC 705/7.28

(57) ABSTRACT

The present invention provides a method and system for calculating an overall risk associated with a project. A set of activities of the project are extracted by an interface module, where the set of activities are assorted into a set of predetermined categories, each category comprising a plurality of phases of execution of the project. A risk value of the each activity can be retrieved from the database. Further, an associated risk value of the each activity can be aggregated by an aggregating module, for calculation of the overall risk.

This application claims the benefit of Indian Patent Application Filing No. 2726/CHE/2013, filed Jun. 24, 2013, which is hereby incorporated by reference in its entirety.

### FIELD

The present invention relates generally to a method and system for risk management. More specifically, the present invention relates to a method and system for measuring risks associated with a project.

### BACKGROUND

Current systems and methods for risk management in a project overlook day to day operations in Software Development Life Cycle (SDLC) processes. Existing models are subject to manual interpretation as they tend to be subjective thereby prohibiting a common understanding or standard across an organization. Further due to incorrect reporting and non-escalation, projects could result into a failure thereby causing considerable angst among stakeholders. Certain existing risk models assign equal weight age to all SDLC tasks and overlook interactions caused between various stakeholders in the SDLC processes. Such risk models provide results based on surface level observations. Such results tend to be faulty in terms of actual risks associated with the project.

Further, existing risk models fail to take into consideration, multiple players in the Software Development Life Cycle (SDLC) of the project. For instance, requirement, design, code, environment and the like risks are owned by a separate set of players each involved in the project. A risk model must take into consideration, testing risks associated with each of the set of players involved in the project.

Hence there is a need for a method and system of calculating an overall risk of a project that shall take into consideration multiple vendors or players involved in each of Business, Design, Code, Infrastructure and testing of the project. Such method and system must address the risk associated with the project by focusing on multiple dimensions of the project such as entry, exit criteria, execution, leadership and relationship. Thus a method and system for calculating an overall risk associated with the project is proposed.

### SUMMARY

The present invention provides a method and system for calculating an overall risk associated with a project. In accordance with a disclosed embodiment, the method may include extracting a set of activities of the project, wherein the set of activities are assorted into a set of predetermined categories, each category comprising of a plurality of phases of execution of the project. Further, a risk value of each activity can be retrieved from a database. Finally, an associated risk value of the each activity is aggregated for calculation of the overall risk of the project.

In an additional embodiment, a system for calculating an overall risk associated with a project is disclosed. The system comprises an interface module, configured to extract a set of activities of the project, wherein the set of activities are assorted into a set of predetermined categories, each category comprising of a plurality of phases of execution of the project. Further, the system includes a database, configured to store a risk value of each activity. The system may further include an aggregating module, configured to aggregate an associated risk value of the each activity for calculation of the overall risk.

These and other features, aspects, and advantages of the present invention will be better understood with reference to the following description and claims.

### BRIEF DESCRIPTION OF THE DRAWINGS

FIG. 1 is a flowchart illustrating an embodiment of a method for calculating an overall risk of a project.

FIG. 2 is a flowchart illustrating an alternate embodiment of a method for calculating an overall risk of a project.

FIG. 3 shows an exemplary system for practicing the instant invention.

FIG. 4 illustrates a generalized example of a computing environment 400.

While systems and methods are described herein by way of example and embodiments, those skilled in the art recognize that systems and methods for electronic financial transfers are not limited to the embodiments or drawings described. It should be understood that the drawings and description are not intended to be limiting to the particular form disclosed. Rather, the intention is to cover all modifications, equivalents and alternatives falling within the spirit and scope of the appended claims. Any headings used herein are for organizational purposes only and are not meant to limit the scope of the description or the claims. As used herein, the word “may” is used in a permissive sense (i.e., meaning having the potential to) rather than the mandatory sense (i.e., meaning must). Similarly, the words “include”, “including”, and “includes” mean including, but not limited to.

### DETAILED DESCRIPTION

Disclosed embodiments provide computer-implemented methods, systems, and computer-program products for calculating an overall risk of a project. The instant invention discloses a quantitative framework to measure the overall risk by focusing on processes, people as well as leadership aspects of a plurality of risks that may occur during an execution of the project. The disclosed embodiment, utilized a weighted average method for calculating the overall risk in a typical Software Development Life Cycle (SDLC) of the project. A higher weight can be assigned to critical activities of the SDLC, while a comparatively lower weight can be assigned to smaller activities. The weighted average method shall ensure a balanced approach for calculating the overall risk. The instant invention can be deployed in technologies such as excel, SharePoint and the like. The disclosed embodiment may include standard SDLC activities that impact a testing of the project. The standard activities may be grouped into a plurality of criteria such as entry, exit, execution, leadership and relationship criteria. Focusing on the plurality of risks that flow into and out of the plurality of criteria, provides an objective assessment of the overall risk, thereby enabling organization to measure a progress of the project, and identify an area of a risk and mitigate the risk.

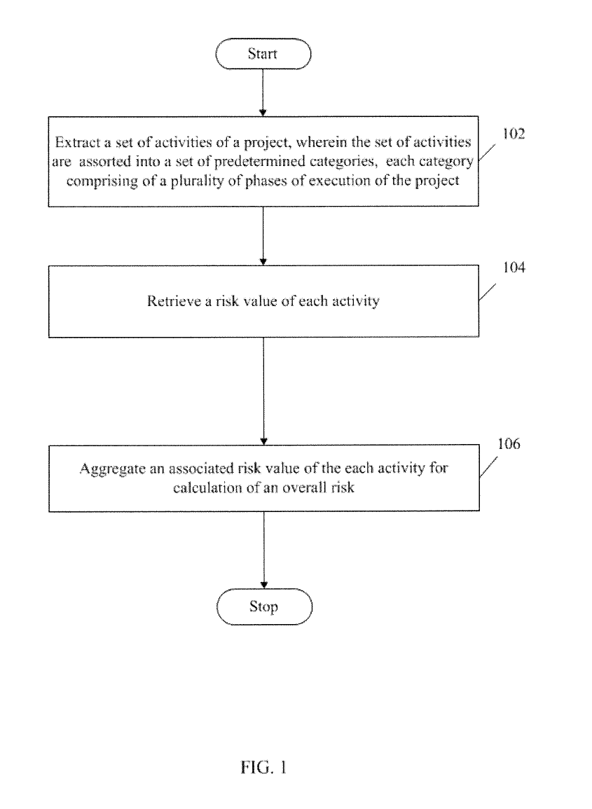

FIG. 1 is a flowchart that illustrates a method performed for calculating an overall risk of a project in accordance with an embodiment of the present invention. At step 102, a set of activities of the project, can be extracted by an interface module, where the set of activities may be stored in a database. The extracted set of activities may be displayed to a user via a front end application such Excel or SharePoint. The set of activities maybe assorted into a set of predetermined categories, each category comprising of a plurality of phases of execution of the project. A risk value of each activity of the set of activities can be retrieved from a database at step 104. The risk value of the each activity can be configured in the database, based on a criticality aspect of the each activity. The risk value can be made configurable based on an experience involved in the project execution. Further at step 106, an overall risk of the project can be computed by aggregating an associated risk value of the each activity, where the associated risk value of the each activity can be inserted by a user based on a completion status of the each activity in the project. The user can be a team member, a project manager and any other person related to the project, interested in determining the overall risk of the project.

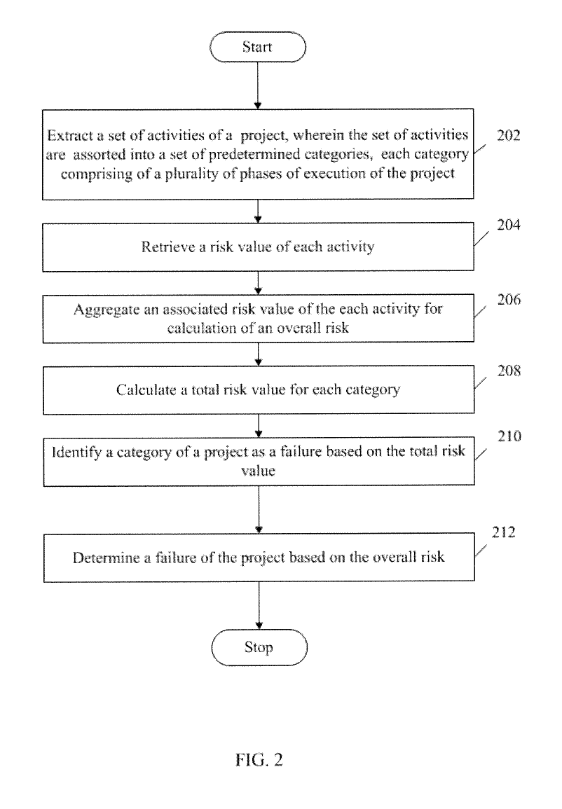

FIG. 2 illustrates an alternate embodiment of a method of practicing the present invention. At step 202, a set of activities of the project, can be extracted by an interface module, where the set of activities may be stored in a database. The extracted set of activities may be displayed to a user via a front end application such Excel or SharePoint. The set of activities maybe assorted into a set of predetermined categories, each category comprising of a plurality of phases of execution of the project. The set of predetermined categories can include entry, leadership, relationship, execution, and exit. Further, the plurality of phases of execution of the project can include an inception phase, an analysis phase, a design phase, a build phase, a test phase, and a deploy phase. A risk value of each activity of the set of activities can be retrieved from a database at step 204. The risk value of the each activity evaluates an impact on the project, when the each activity is incomplete. The risk value of the each activity can be configured in the database, based on a criticality aspect of the each activity. For instance, an activity whose failure results in a major threat to the project is usually assigned a high risk value. Alternatively, an activity whose completion merely delays certain formalities of the project can be assigned a low risk value. The risk value for the activity can be altered based on an experience involved in the project execution. Further at step 206, an overall risk of the project can be computed by aggregating an associated risk value of the each activity, where the associated risk value of the each activity can be inserted by a user based on a completion status of the each activity in the project. For instance, the associated risk value of the each activity is zero when the input indicates the each activity is complete. the associated risk value of the each activity is assigned the retrieved risk value when the input indicates the each activity is incomplete.

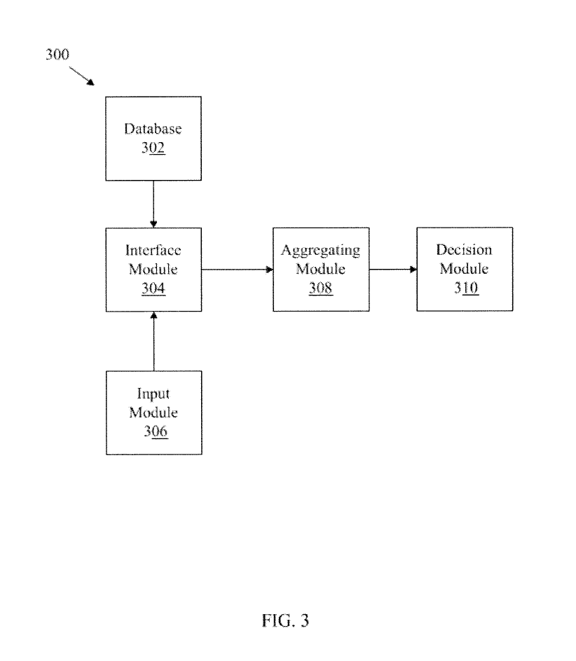

FIG. 3 illustrates an exemplary system 300 in which various embodiments of the invention can be practiced. The exemplary system 300 includes a database 302, an interface module 304, an input module 306, an aggregating module 308, and a decision module 310. The interface module 304, maybe designed to interface with the input module 306, for receiving inputs on a set of activities of a project from a user of the project. The user in an instance can be a project manager, a team member, an administrator and the like. The interface module 304, can extract a set of activities of the project from the database 302, where the set of activities are assorted into a set of predetermined categories or criteria such as entry criteria, leadership criteria, relationship criteria, execution criteria, and exit criteria. Each category comprises of a plurality of phases of execution of the project such as an inception phase, an analysis phase, a design phase, a build phase, a test phase, and a deploy phase. As a result, each phase and category of the project includes a subset of the set of activities. Further, the database 302, can store a risk value associated with the each activity. The risk value of the each activity basically evaluates an impact on the project, when the each activity is incomplete. Alternatively the risk value indicates a risk of failure of the project associated with an incompleteness of the activity. The input module 306, shall receive an input for an associated risk value of the each activity from the user where the input shall indicate a completion of the each activity. The associated risk value shall be zero when the activity is complete, and shall be the risk value of the activity as stored in the database 302, when the activity is incomplete.

On receiving the input for the each activity of the project, the aggregating module 308, can aggregate the associated risk value of the each activity for calculation of the overall risk. The aggregating module 308 can also calculate a total risk value of the each category by a process of summation of the risk value associated with the subset of activities present in the each category. The decision module 310, can identify based on the total risk value of the each category, a category of failure of the project. For instance, if the entry criteria, has a high total risk value, it shall imply that the subset of activities involved in the entry category of the project have not been completed, and hence need to be adhered to in order to avoid a failure of the project. As a result, point of failures and reasons for a failure of the project can be easily identified through the disclosed system. Further the decision module 310, can determine a failure of the project based on the overall risk of the project.

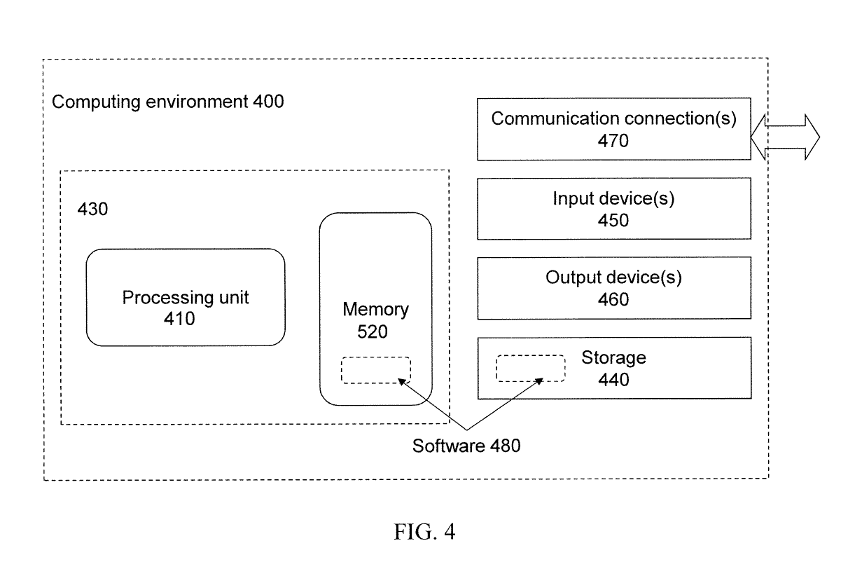

One or more of the above-described techniques can be implemented in or involve one or more computer systems. FIG. 4 illustrates a generalized example of a computing environment 500. The computing environment 500 is not intended to suggest any limitation as to scope of use or functionality of described embodiments.

With reference to FIG. 4, the computing environment 400 includes at least one processing unit 410 and memory 420. In FIG. 4, this most basic configuration 430 is included within a dashed line. The processing unit 410 executes computer-executable instructions and may be a real or a virtual processor. In a multi-processing system, multiple processing units execute computer-executable instructions to increase processing power. The memory 420 may be volatile memory (e.g., registers, cache, RAM), non-volatile memory (e.g., ROM, EEPROM, flash memory, etc.), or some combination of the two. In some embodiments, the memory 420 stores software 480 implementing described techniques.

A computing environment may have additional features. For example, the computing environment 400 includes storage 440, one or more input devices 440, one or more output devices 460, and one or more communication connections 470. An interconnection mechanism (not shown) such as a bus, controller, or network interconnects the components of the computing environment 400. Typically, operating system software (not shown) provides an operating environment for other software executing in the computing environment 400, and coordinates activities of the components of the computing environment 400.

The storage 440 may be removable or non-removable, and includes magnetic disks, magnetic tapes or cassettes, CD-ROMs, CD-RWs, DVDs, or any other medium which can be used to store information and which can be accessed within the computing environment 400. In some embodiments, the storage 440 stores instructions for the software 480.

The input device(s) 450 may be a touch input device such as a keyboard, mouse, pen, trackball, touch screen, or game controller, a voice input device, a scanning device, a digital camera, or another device that provides input to the computing environment 400. The output device(s) 460 may be a display, printer, speaker, or another device that provides output from the computing environment 400.

The communication connection(s) 470 enable communication over a communication medium to another computing entity. The communication medium conveys information such as computer-executable instructions, audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

Implementations can be described in the general context of computer-readable media. Computer-readable media are any available media that can be accessed within a computing environment. By way of example, and not limitation, within the computing environment 400, computer-readable media include memory 420, storage 440, communication media, and combinations of any of the above.

Having described and illustrated the principles of our invention with reference to described embodiments, it will be recognized that the described embodiments can be modified in arrangement and detail without departing from such principles. It should be understood that the programs, processes, or methods described herein are not related or limited to any particular type of computing environment, unless indicated otherwise. Various types of general purpose or specialized computing environments may be used with or perform operations in accordance with the teachings described herein. Elements of the described embodiments shown in software may be implemented in hardware and vice versa.

As will be appreciated by those ordinary skilled in the art, the foregoing example, demonstrations, and method steps may be implemented by suitable code on a processor base system, such as general purpose or special purpose computer. It should also be noted that different implementations of the present technique may perform some or all the steps described herein in different orders or substantially concurrently, that is, in parallel. Furthermore, the functions may be implemented in a variety of programming languages. Such code, as will be appreciated by those of ordinary skilled in the art, may be stored or adapted for storage in one or more tangible machine readable media, such as on memory chips, local or remote hard disks, optical disks or other media, which may be accessed by a processor based system to execute the stored code. Note that the tangible media may comprise paper or another suitable medium upon which the instructions are printed. For instance, the instructions may be electronically captured via optical scanning of the paper or other medium, then compiled, interpreted or otherwise processed in a suitable manner if necessary, and then stored in a computer memory.

The following description is presented to enable a person of ordinary skill in the art to make and use the invention and is provided in the context of the requirement for a obtaining a patent. The present description is the best presently-contemplated method for carrying out the present invention. Various modifications to the preferred embodiment will be readily apparent to those skilled in the art and the generic principles of the present invention may be applied to other embodiments, and some features of the present invention may be used without the corresponding use of other features. Accordingly, the present invention is not intended to be limited to the embodiment shown but is to be accorded the widest scope consistent with the principles and features described herein.

While the foregoing has described certain embodiments and the best mode of practicing the invention, it is understood that various implementations, modifications and examples of the subject matter disclosed herein may be made. It is intended by the following claims to cover the various implementations, modifications, and variations that may fall within the scope of the subject matter described.

What is claimed:

1. A method for calculating an overall risk associated with a project, the method comprising:
extracting, by a risk management computing device, a set of activities of the project, wherein the set of activities are assorted into a set of predetermined categories, each category comprising of a plurality of phases of execution of the project;
retrieving, by the risk management computing device, a risk value of each activity;
aggregating, by the risk management computing device, an associated risk value of the each activity for calculation of the overall risk.

2. The method of claim 1, wherein the set of predetermined categories comprise at least one or more of entry, leadership, relationship, execution, or exit.

3. The method of claim 1, wherein the plurality of phases of execution of the project comprise at least one or more of an inception phase, an analysis phase, a design phase, a build phase, a test phase, or a deploy phase.

4. The method of claim 1, wherein the risk value of the each activity evaluates an impact on the project, when the each activity is incomplete.

5. The method of claim 1, further comprising:
receiving, by the risk management computing device, an input for the associated risk value of the each activity, the input indicating the completion of the each activity.

6. The method of claim 5, wherein the associated risk value of the each activity is zero when the input indicates the each activity is complete.

7. The method of claim 5, wherein the associated risk value of the each activity is assigned the retrieved risk value when the input indicates the each activity is incomplete.

8. The method of claim 1, further comprising:
calculating, by the risk management computing device, a total risk value for the each category;
identifying, by the risk management computing device, a category of the project as a failure based on the total risk value; and
determining, by the risk management computing device, a failure of the project based on the overall risk.

9. A risk management computing device comprising:
a processor coupled to a memory and configured to execute programmed instructions stored in the memory, comprising:
extracting a set of activities of the project, wherein the set of activities are assorted into a set of predetermined categories, each category comprising of a plurality of phases of execution of the project;
storing a risk value of each activity; and
aggregating an associated risk value of the each activity for calculation of the overall risk.

10. The device of claim 9, wherein the set of predetermined categories comprise at least one or more of entry, leadership, relationship, execution, or exit.

11. The device of claim 9, wherein the plurality of phases of execution of the project comprise at least one or more of an inception phase, an analysis phase, a design phase, a build phase, a test phase, or a deploy phase.

12. The device of claim 9, wherein the risk value of the each activity evaluates an impact on the project, when the each activity is incomplete.

13. The device of claim 9, wherein the processor is further configured to execute programmed instructions stored in the memory further comprising:
receiving an input for the associated risk value of the each activity, the input indicating a completion of the each activity.

14. The device of claim 13, wherein the associated risk value of the each activity is zero when the input indicates the each activity is complete.

15. The device of claim 13, wherein the associated risk value of the each activity is assigned the retrieved risk value when the input indicates the each activity is incomplete.

16. The device of claim 9, wherein the processor is further configured to execute programmed instructions stored in the memory further comprising:
calculating a total risk value for the each category. identifying a category of the project as a failure based on the total risk value; and
determining a failure of the project based on the overall risk.

17. A non-transitory computer readable medium having stored thereon instructions for calculating an overall risk associated with a project comprising machine executable code which when executed by a processor, causes the processor to perform steps comprising:
extracting a set of activities of the project, wherein the set of activities are assorted into a set of predetermined categories, each category comprising of a plurality of phases of execution of the project;
storing a risk value of each activity; and
aggregating an associated risk value of the each activity for calculation of the overall risk.

18. The medium of claim 17, wherein the set of predetermined categories comprise at least one or more of entry, leadership, relationship, execution, or exit.

19. The medium of claim 17, wherein the plurality of phases of execution of the project comprise at least one or more of an inception phase, an analysis phase, a design phase, a build phase, a test phase, or a deploy phase.

20. The medium of claim 17, wherein the risk value of the each activity evaluates an impact on the project, when the each activity is incomplete.

21. The medium of claim 17, wherein the medium further comprises machine executable code which, when executed by the processor, causes the processor to perform steps further comprising:
receiving an input for the associated risk value of the each activity, the input indicating a completion of the each activity.

22. The medium of claim 21, wherein the associated risk value of the each activity is zero when the input indicates the each activity is complete.

23. The medium of claim 21, wherein the associated risk value of the each activity is assigned the retrieved risk value when the input indicates the each activity is incomplete.

24. The medium of claim 17, wherein the medium further comprises machine executable code which, when executed by the processor, causes the processor to perform steps further comprising:
calculating a total risk value for the each category.
identifying a category of the project as a failure based on the total risk value; and
determining a failure of the project based on the overall risk.
